(19) United States
(12) Patent Application Publication
(10) Pub. No.: US 2024/0284873 A1
(43) Pub. Date: Aug. 29, 2024

(54) Robodayton Hybrid System

(71) Applicant: Zaid Almanssoori, Dayton, OH (US)

(72) Inventor: Zaid Almanssoori, Dayton, OH (US)

(21) Appl. No.: 18/113,622

(22) Filed: Feb. 24, 2023

(51) Int. Cl. A01K 27/00; A01K 11/00; B25J 13/00; B25J 13/06; B25J 15/00; B25J 19/04; F41C 33/00

(52) U.S. Cl. CPC A01K 27/002; A01K 11/008; B25J 13/003; B25J 13/06; B25J 15/0066; B25J 19/04; F41C 33/001

(57) ABSTRACT

A hybrid system includes a combination of a robotic arm with a real dog. This combination enables to do a new function that the normal dog cannot do it. This function depends on the type of robotic arm and the kind of the dog. An attachment is very important part in the hybrid system and it is used to physically attach the robotic arm to the real dog. This attachment should be sturdy and strong. This attachment may be a dog harness or the robotic arm may be attached directly to the dog. The robotic arm can be controlled manually or automatically. This hybrid system may be provided with several sensors and/or detecting devices to help in several tasks. This invention is easy to apply with the low cost. This system can be used in different fields.

### CROSS-REFERENCE TO RELATED DOCUMENTS

The present specification claims priority to provisional patent application No. 63/412,890 filed on Oct. 4, 2022, and all disclosure of that parent case is incorporated at least by reference.

### BACKGROUND OF THE INVENTION

### 1. Field of the Invention

The present invention is in the field of robotic systems and pertains particularly to hybrid system which is a combination of a robotic arm with a real dog for achieving several tasks. An attachment is used to strongly attach these parts together. This system is equipped and reinforced with different technologies, which are helpful in several fields.

### 2. Discussion of the State of the Art

The dogs are very important in our daily life. They are very useful in our homes. Most people also interact with their dogs in the different activities. Some dogs are used in security and military fields. Other dogs can be used for disability services. It's easy to teach and train these dogs.

In some related applications, some dogs are also used to pick up something using their mouths. They also have the ability to go quickly to any location, but they cannot properly pick up anything, handle materials or fix any problem that requires an arm or a tool for that.

On the other hand, robots have arms and tools to deal with these problems, but it can be challenging to drive these robots to the path with obstacles existence or lack of training. There are several robotic dogs that are available, but these robotic dogs are expensive with some problems about controlling and driving. Some tasks required specific dogs such as service dogs, police dogs, etc. Moreover, People prefer using their dogs instead of the robotic machines for reaching to the target destination or for going to specific areas to do something. Some dogs has the ability to smell and to detect suspicious items; so they are useful in the security fields.

Therefore, what is clearly needed is to improve a system to address all these issues. A hybrid system is invented in this project. This system consists of a real dog combined with a robotic arm. These parts should be sturdily attached together using an attachment. This system enables to do a new function that the normal dog cannot do. This hybrid system eliminates expense of using the whole robotic dog, moreover it gives better results.

### SUMMARY OF THE INVENTION

The main concept of this invention, a hybrid system is provided comprising a combination of a robotic arm with a real dog. This combination enables to do a new function that the normal dog cannot do it. This function depends on the type of robotic arm and the kind of the dog. An attachment is very important part in this system and it is used to sturdily attach the robotic arm to the real dog. The attachment that is used to attach the robotic arm to the real dog may be a dog harness or the robotic arm may attach directly to the dog. In one embodiment of this invention, the robotic arm can be attached and mounted on the back of the dog or on his chest. In one embodiment of the present invention, another type of the animals can be used instead of the dog to get a similar result of this hybrid system. In one embodiment of the invention, multiple robotic arms can be used instead of one robotic arm.

In one embodiment of the invention, the controlling of the robotic arm can be a remote controller, a smart device, or a PC. In one embodiment of the present invention, the robotic arm can be controlled manually or automatically. In one embodiment of the invention, the automatic controller can be intelligent controller or using a voice command. In one embodiment of the invention, the robotic arm has an end effector or the end effector can be a part of the robotic arm. In one embodiment of the invention, the end effector of the robotic arm can be changed depending on the required task. In one embodiment of the invention, multiple end effectors can be used instead of an individual end effector.

In one embodiment of the present invention, this hybrid system may be provided with several sensors and/or detecting devices to help in several tasks. In one embodiment of the invention, a camera or multiple cameras are attached to the robotic arm to help in controlling and in monitoring the operation of the system. In one embodiment of the invention, the robotic arm may be provided with a controllable weapon such a gun or a laser which helps in the security and military fields. In one embodiment of the invention, a controllable weapon can be attached directly to the harness of the dog. In one embodiment of the invention, a global positioning satellite (GPS) is used for providing GPS coordinates to know the location and to help in the navigation.

### BRIEF DESCRIPTION OF THE DRAWING FIGURES

FIG. 1 is a perspective view illustrating a hybrid system according to this invention.

FIG. 2 illustrates a hybrid system with drilling end effector according to an embodiment of the present invention.

FIG. 3 is a perspective view of a hybrid system with multiple robotic arms according to an embodiment of the present invention.

FIG. 4 illustrates a hybrid system of the present invention in bomb disposal application.

FIG. 5 is front view of a prototype (product) of application of this hybrid system according to this invention.

FIG. 6 is a top view of a real prototype of FIG. 5.

### DETAILED DESCRIPTION OF THE INVENTION

The inventor provides a hybrid system from the combination of the real dog with robotic arm. The robotic arm should stay mounted and sturdily attached on the dog using an attachment and all these parts should be together as long as the dog moves and during the entire required task. The present invention is described in enabling details using the following examples and a prototype, which may describe more than one relevant embodiment falling within the scope of the present invention.

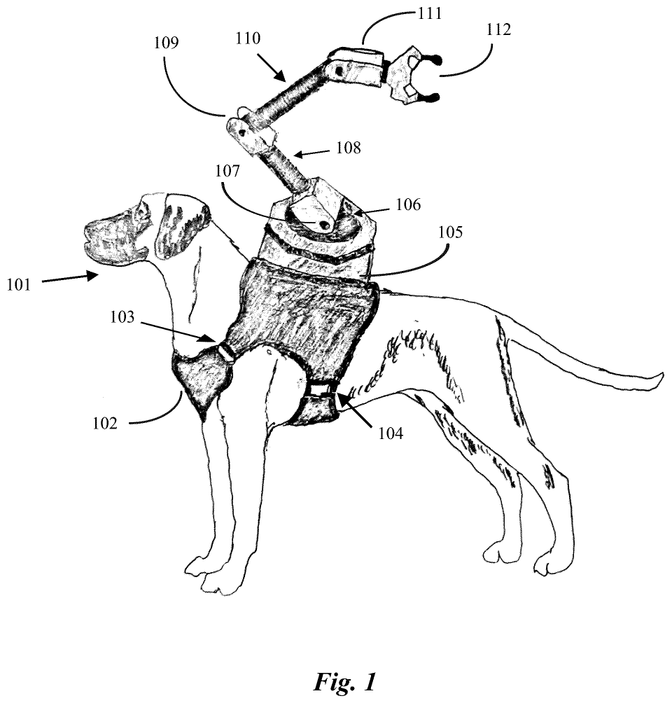

FIG. 1 represents a perspective view of a hybrid system according to this invention. In this figure, the robotic arm is mounted and attached with a real dog 101 using an attachment and this represents the main concept of the present invention. The attachment of the dog with robotic arm is a harness 102 of the dog. The robotic arm is attached to the harness 102 using a harness attachment 105. The robotic arm may be attached directly to the dog or can use any method for attaching without departing from the spirit and scope of the invention.

A real dog 101 can be any dog who has the ability to follow the instruction or any dog that is used for doing a specific task. This dog should have the ability to move normally and the robotic arm should be able to attach with this dog. A dog harness 102 can be any harness that the dog should wear during the required task. This harness should be fit to the size of the dog and it should be adjustable on the dog. This harness should have the ability to attach with the required type of the robotic arm.

Front adjustment points 103 are located between the shoulder of the dog and his neck. They are used for adjusting the front side of the harness to the dog to fit snugly. Rear adjustment points 104 are located under the belly of the dog. They are used for adjusting the rear side of the harness on the dog to be comfortable.

A harness attachment 105 is the part that is used to attach the robotic arm to the dog harness 102. This attachment 105 should be sturdy and reliable to work under all conditions. The harness attachment 105 should be chosen or should be made depending on the dog harness type and the base of the robotic arm without departing from the spirit and scope of the invention. The robotic arm can be mounted and attached on the back of the dog or on his chest.

In this example, there are several parts of the robotic arm, which are a base of the robotic arm 106, shoulder 107, first arm 108, elbow 109, second arm 110, wrist 111 and end effector gripper 112. The robotic joints provide a relative motion between two links. The shoulder 107 rotates the first arm 108 while the elbow 109 rotates the second arm 109. In this example, the base of the robotic arm 106 rotates the entire assembly or the whole robotic arm. The wrist 111 can rotate in any direction. The wrist provides three degrees of freedom, which are pitch, yaw and roll. A robotic arm that is mounted on the dog can be any type. The type of the robotic arm is chosen depending on the required task without departing from the spirit and scope of the invention.

End effector 112 can be attached at the end of the robotic arm or at the wrist of this arm. End effector 112 is chosen depending on the required task. It is used for a purpose to carry out a specific function and this allows our whole system to work and to interact with the task such as picking up, holding, cutting, moving, opening etc. End effector can be replaced with another one depending on the application and the environment without departing from the spirit and scope of the invention. End effector 112 in this example is a gripper. In one embodiment of the invention, the robotic arm may have multiple end effectors instead of an individual end effector. For example, a system can have two end effectors, one can hold a small object while the other one can hold a big object or doing another task.

The operator in this example may use a remote control to wirelessly connect with the robotic arm. In one embodiment of the invention, the controlling of the robotic arm can be a smart device or a PC, which means we can use a cellphone or a laptop to control the process of the robotic arm. The robotic arm can be controlled manually or automatically. The automatic controller can be intelligent controller or using a voice command, which means that the robotic arm can achieve the tasks without manually controlled by the operator. Here a voice can be received via a remote controller or via a smart device.

Stability and good control system in the robotic arm are very important for all uncertainty conditions. These conditions happen in the dog action such as dog jumping, running, etc. Some conditions happen due to the disturbance form the environment. The results of the performance of the robotic arm will be affected by these conditions with a lot of vibration; so a good control system is required to eliminate all these problems with good stability in the system.

The hybrid system is cheap and can be quickly applied and adapted. This system can be easily modified by choosing another type of robotic arms or by changing the end effector depending on the desired task without departing from the spirit and scope of the invention. Several sensors and/or detecting devices can be provided in this system such as limit switch or photo sensor. Sensors and detecting devices are used to ensure a smooth function of this system and to understand the environment.

It should be considered the interaction between the dog function and the purpose of robotic arm. For instance, the dog has the ability to walk, run, creep, climb while the robotic arm that is mounted and attached on the dog can do another work such as picking up things, opening a door, cutting flowers, drilling a wall, or dealing with other tasks. It is very hard for the dog to do these functions by himself without using this robotic arm; so this arm is very important in this kind of tasks.

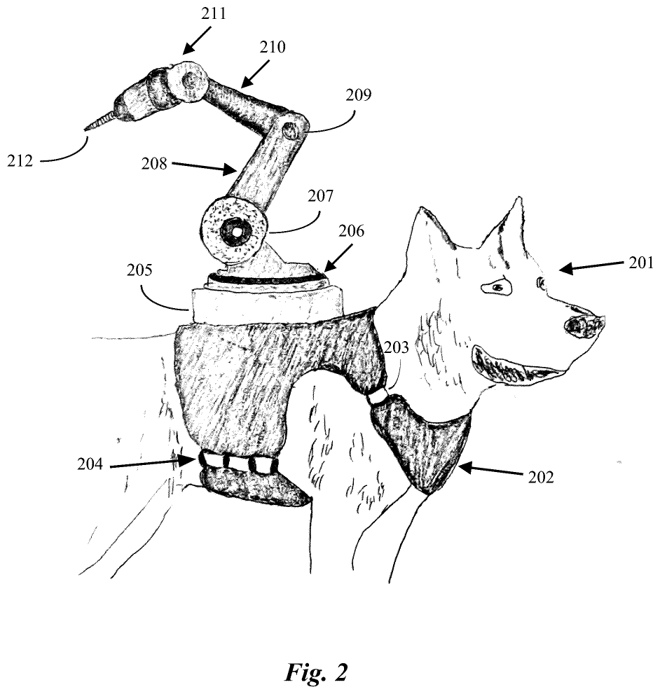

FIG. 2 is another example illustrating the invention of this hybrid system with drilling end effector. The hybrid system in this example is also applied by combination the real dog 201 with the robotic arm using a strong attachment. In this example, we use another type of a dog with another type of the robotic arm but with same principle of this invention by applying this hybrid system. The harness 202 in this example is also another type of the harness but with the same principle of the hybrid system. All these changes are acceptable in the hybrid system if they are effective and necessary but without departing from the spirit and scope of the invention.

In this example, front adjustment points 203 and rear adjustment points 204 are used to adjust the size of the harness 202 to be fitted and comfortable for the dog. The dog harness 202 should be attached with the robotic arm using harness attachment 205 and this attachment should be strong and sturdy. It should take into consideration the selection of the arm weight, its feature with the dog size and his ability to interact and to carry this arm.

In this example, the robotic arm also consists of several parts like the previous example. These parts are base of the robotic arm 206, shoulder 207, first arm 208, elbow 209, second arm 210, wrist 211, and end effector drilling 212. The wrist 211 has two rotations, which are pitch and yaw. The end effector 212 in this example is a different type from the end effector of the previous example in order to carry out a different function. The end effector 212 can be replaced with another type depending on the application without departing from the spirit and scope of the invention.

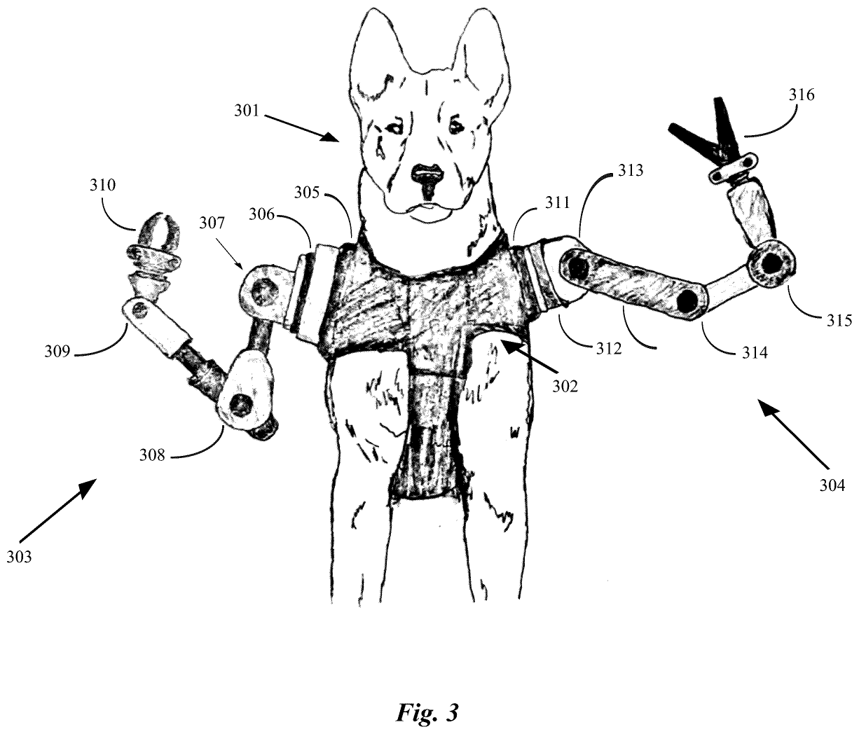

FIG. 3 is another example illustrating this hybrid system with multiple robotic arms. In one embodiment of the invention, several robotic arms can be used instead of one robotic arm. In this example, we use a real dog 301 but with two different robotic arms attached to the dog but with the same principle of this invention by applying this hybrid system. These robotic arms are (robotic arm A) 303 and (robotic arm B) 304. Both robotic arms are attached to the same harness 302 but using two harness attachments. The (robotic arm A) 303 is attached to the harness 302 using harness attachment A 305, while (robotic arm B) 304 is attached to the same harness 302 using different harness attachment B 311. Front adjustment points 317 and rear adjustment points 318 are used to adjust the size of the harness to be fitted and comfortable with the dog.

In this example, the (robotic arm A) 303 consists of parts like any robotic arm. These parts are robotic arm A base 306, robotic arm A shoulder 307, robotic arm A elbow 308, robotic arm A wrist 309 and robotic arm A end effector gripper 310. The (robotic arm B) 304 also consists of parts like any robotic arm. These parts are robotic arm B base 312, robotic arm B shoulder 313, robotic arm B elbow 314, robotic arm B wrist 315 and robotic arm B end effector cutter 316.

Here each robotic arm will achieve a specific function but both robotic arms should work together and should cooperate to achieve the same task. A task of cutting and picking up flowers is an example of this application and these two robotic arms are attached to the dog. The robotic arm A 303 is used to hold the flower while the robotic arm B 304 is used to cut this flower and during this time robotic arm A 303 will keep holding this flower after cutting. Then after that, the dog can come back while the robotic arm A 303 that attached to the dog will grasp this flower.

We can replace these types of the robotic arms that attached to the dog with another types. We can also replace a type of the end effector with another type. We can do all these changes if they are effective and necessary and depending on the required task without departing from the spirit and scope of the invention.

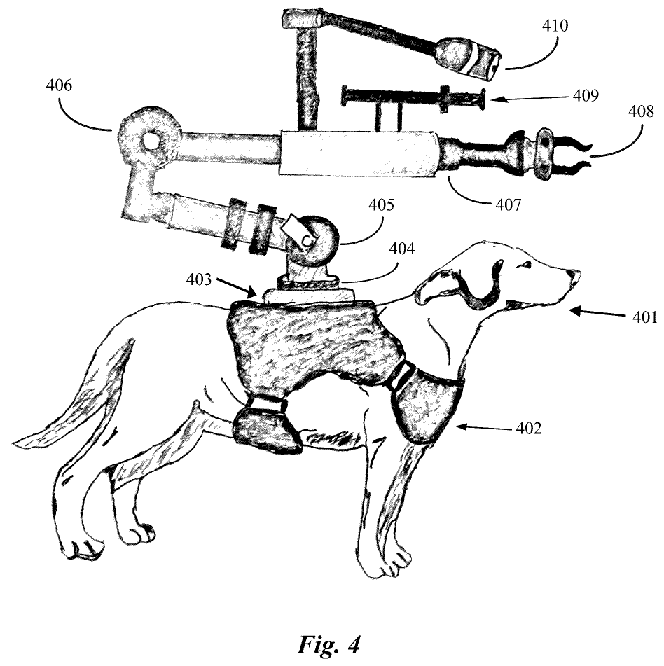

This hybrid system can also work in the dangerous areas where the humans cannot approach. A dog can reach to these unsafe places and can work with the attached robotic arm together for dealing with any suspicious item such as a bomb. The hybrid system can perform specific missions such as a bomb disposal function. FIG. 4 illustrates a hybrid system of the present invention in bomb disposal application.

In FIG. 4, the robotic arm is mounted and is attached with a real dog 401 using an attachment and this represents the main concept of the present invention. A real dog can be any dog that is used for security fields. The attachment in this example is a dog harness 402. The robotic arm is attached with the dog harness 402 using the harness attachment 403. The harness attachment 403 should be very strong and sturdy during the dog running. A shield can be put on the dog or the dog harness can be protective harness.

The type of the robotic arm used in this example is bomb-disposal robot arm. There are several parts of the robotic arm in this example, which are base of the robotic arm 404, shoulder 405, elbow 406, wrist 407, and end effector gripper 408.

In this figure the robotic arm may be provided with a controllable weapon 409 to help in the security tasks. In another embodiment of the invention, a camera can be attached to this robotic arm. In this example, we attach camera 410 with the robotic arm to monitor the operation of the system and to help in the controlling process. Some tools and devices can be also provided for rescue and security missions.

The dog can reach to the bombs or suspicious items while the robotic arm that is attached on the dog can handle these items such as disposing the bombs or removing suspicious materials. The operator can be far away from these areas and can control the robotic arm remotely. Several sensors and/or detecting devices can be provided with this system. Sensors and detecting devices may be very important in unsafe environments or in the rescue tasks.

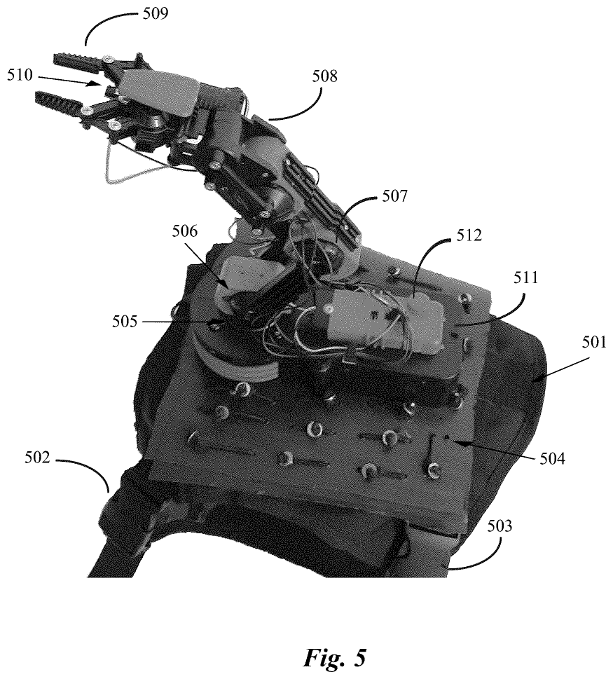

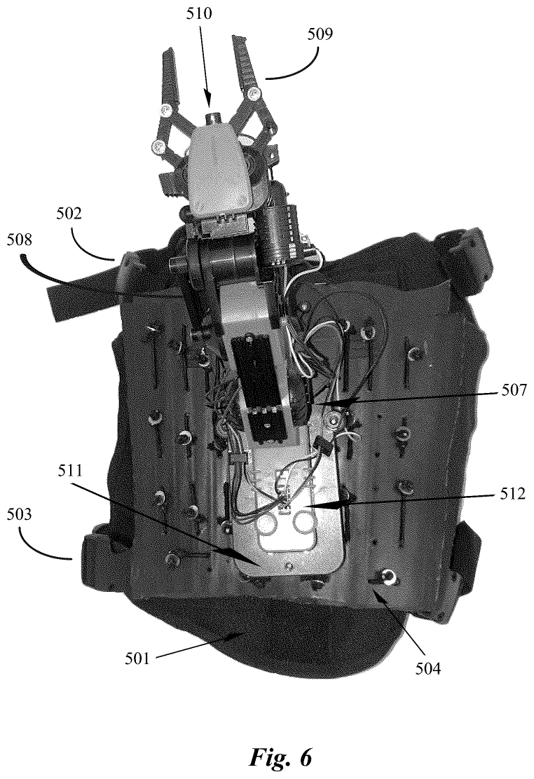

A first prototype or the first product of Robodayton hybrid system has been made as shown in FIG. 5 for the front view and as shown in FIG. 6 for the top view of this product. This product is simple and cheap. We used a whole robotic arm and a dog harness. The principle of this invention has been applied by just attaching these two parts of the robotic arm with a dog harness 501 together using a harness attachment 504.

These parts should be strongly attached together to make sure that the system sturdy and reliable during several conditions related to the dog action such walking, running, jumping, creeping, etc. We have to make sure that this arm should be still mounted and attached with the dog wherever he goes and during the entire task. This product is so light and the dog could wear it. The arm is stable and effective during the dog movement.

The harness has adjustment points, which are used to adjust the size of the harness to be fitted with the dog. The front adjustment points 502 are used to adjust the front part of the dog while the rear adjustment points 503 are used for the rear part of the dog. We have to make sure the size of dog should be fit with this harness.

The robotic arm consists of parts, which are base of the robotic arm 505, shoulder 506, elbow 507, wrist 508, end effector gripper 509, light 510, battery holder 511 and controller unit 512. The controller type in this product is manual controller. The operator is used a remote control for controlling the robotic arm.

1. A hybrid system is comprised of
a combination of a robotic arm and a real dog wherein this combination enables to do a new function that the normal dog cannot do it; and
an attachment is used to attach the robotic arm to the real dog and this attachment should be sturdy and strong.

2. The system of claim 1 wherein the attachment of the robotic arm with the real dog may be a dog harness or the robotic arm may be attached directly to the dog.

3. The system of claim 1 wherein the robotic arm can be attached and mounted on the back of the dog or on his chest.

4. The system of claim 1 wherein another type of the animals can be used instead of the dog to get the similar result of this hybrid system.

5. The system of claim 1 wherein multiple robotic arms can be used instead of one robotic arm.

6. The system of claim 1 wherein the controlling of the robotic arm can be a remote control, a smart device, or a PC.

7. The system of claim 1 wherein the robotic arm can be controlled manually.

8. The system of claim 1 wherein the robotic arm can be controlled automatically.

9. The system of claim 8 wherein the automatic controller can be intelligent controller or using a voice command.

10. The system of claim 1 wherein the robotic arm has an end effector or the end effector can be a part of the robotic arm.

11. The system of claim 10 wherein the end effector of the robotic arm can be changed depending on the required task.

12. The system of claim 10 wherein multiple end effectors can be used instead of one end effector.

13. The system of claim 1 further comprising several sensors and/or detecting devices.

14. The system of claim 1 further comprising a camera or multiple cameras, which are attached to the robotic arm.

15. The system of claim 1 wherein the hybrid system may be provided with a controllable weapon such a gun or a laser, which helps in the security and military fields.

16. The system of claim 15 wherein said a controllable weapon can be attached directly to the harness of the dog or to the robotic arm.

17. A controllable weapon is attached to the dog harness with or without existence a robotic arm.

18. The system of claim 1 further comprising a global positioning satellite (GPS) for providing GPS coordinates to know the location and to help in the navigation.
